(19) United States
(12) Patent Application Publication
(10) Pub. No.: US 2003/0156687 A1
(43) Pub. Date: Aug. 21, 2003

(54) Data transmission method, in particular advertising information, on a user terminal

(76) Inventor: Jacques Messager, Liffre (FR)

Correspondence Address: Gerald E Helget, Briggs and Morgan, 2400 IDS Center, 80 South Eighth Street, Minneapolis, MN, 55402, US

(21) Appl. No.: 10/312,171

(22) PCT Filed: Jun. 8, 2001
(86) PCT No.: PCT/FR01/01797

(30) Foreign Application Priority Data
Jun. 23, 2000 (FR) 00/08046

(51) Int. Cl. H04M 1/64

(52) U.S. Cl. 379/67.1

(57) ABSTRACT

This invention relates to a method for transmitting information, particularly advertising information, to a user terminal capable of accessing a telecommunication network in packet mode and in circuit mode, wherein when a first connection through the network is established with said terminal according to either mode, a second connection in packet mode is established at the same time as the first connection between said terminal and an information server, and the server then transmits said information to the user terminal by means of the second connection.

This invention concerns in general a method for transmitting information to a user terminal. More specifically, this invention concerns a method for transmitting advertising information to a user terminal from a network offering access in packet mode and access in circuit mode.

Various methods for transmitting advertising information to a user terminal are known in the current state of the art.

First of all, the techniques for disseminating advertising information via the Internet are widely used. We know, in particular that when a user establishes a TCP link with a Web server, the server can use this link to transmit advertising information to him at the application software level. This information is then displayed on his terminal, generally in the form of banners. The advertising information is sent, for example, by the server in PUSH mode to the TCP link; in other words, the advertising data is delivered immediately to the user application layer. Depending on the mode of dissemination, advertising receipts are collected by the content suppliers or the service suppliers and not by the network operator. Additionally, the transmission of advertising messages disrupts and slows down the transmission of useful information to the user.

Application WO-A-9834392 also discloses how to invoice all or part of a communication between two subscribers to a third-party advertiser. According to this method, when a subscriber wants to contact another subscriber at a reduced rate, he enters his correspondent's number preceded by a determined prefix. When the prefix is detected by the network, the communication is routed via the advertiser's server, which can then transmit its advertising messages over the link. In exchange, the network passes the invoicing on to the advertiser. This method is complex because it requires cutting a network element and rerouting the communication. Additionally, it disrupts the communication between two subscribers even though one of them has not subscribed to the advertising messaging service.

A method for disseminating advertising messages allowing the collection of receipts by the network operator was proposed in utility certificate application FR-A-2756695. According to this method, as soon as a mobile terminal is turned on, the network routinely sends it an advertising message that is then displayed on the screen. This method has the disadvantage of routinely using a portion of the radio resources shared by different active mobile stations and of not targeting the different users. It also has the disadvantage of being very limited, since the display is restricted to the network access time.

We are also familiar with SMS (Short Message Service) in the GSM system. This service currently makes it possible to send and receive short messages via the signaling network. When a message is received, an indicator is generally displayed on the user's terminal and the user can then read it. This type of service does not lend itself to the dissemination of advertising messages because it assumes a prior action on the part of the user.

The goal of this invention is to propose a method for transmitting advertising messages that does not have the aforementioned disadvantages, namely, that is simple to use, does not disturb the subscriber's communication and delivers advertising messages to the subscriber in selective and continuous fashion and allows the operator to offer a reduced rate in exchange for the collection of advertising receipts.

Furthermore, an important advantage of this invention resides in the fact that it is applicable to any type of communication: voice, videophonic or even data transfer, whether this communication is carried out in circuit mode or in packet mode.

To this end, the method according to this invention is implemented thanks to a telecommunication network offering its users access in packet mode and access in circuit mode wherein when at least a first connection through the network is requested by said terminal, according to either mode, a second connection in packet mode is established at the same time as the first connection between said terminal and an information server and the server then transmits said information to the user terminal by means of the second connection.

Advantageously, the server establishes the second connection upon confirmation of the establishment of the first connection.

What's more, when the user terminal accesses the network by means of a multiplicity of connections including the first and second connections, the second connection is advantageously freed up when the network detects the end of the other connections.

According to a first feature, a first database is consulted at the time the first connection is established and the second connection is established only if the first database indicates that the user is a subscriber to the information service.

The server can then select information to transmit to the subscriber from a second database based on the subscriber's characteristics, particularly his preferences, listed in a third database.

The server can even select the information to be transmitted to the subscriber from a database based on the subscriber's location.

According to a second feature of the invention, the server selects a presentation format for the information based on the type of user terminal.

According to a third feature of the invention, the information is advertising and is represented on the terminal in the form of banners. The number of clicks on these banners and/or the display time of said banners is then taken into account to calculate the billing of the communication on the connection or connections other than the second connection.

According to a fourth feature of the invention, the information is transmitted to the user terminal in the form of TCP segments in which the PSH push flag is raised.

According to an initial application mode, the method according to the invention is applicable to a UMTS telecommunication network.

According to a second application mode, the method according to the invention is applicable to a GSM/GPRS telecommunication network.

According to a third application mode, the method according to the invention is applicable to an ISDN network.

The invention also concerns a system suited to using the method presented above.

Finally, the invention concerns a smart software for managing the network service, a server control software program and a database management software program suited for use with the method presented above.

The features of the invention mentioned above, as well as others, will become clearer upon reading the following description given in relation to the appended figures.

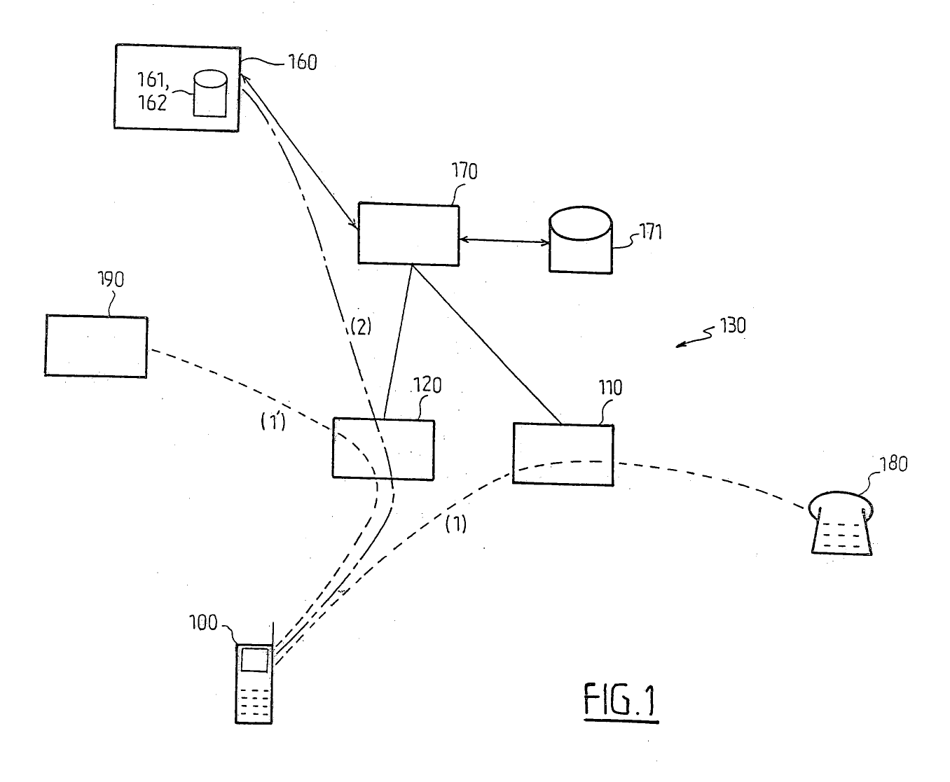

FIG. 1 is a schematic representation of the general principle of the invention;

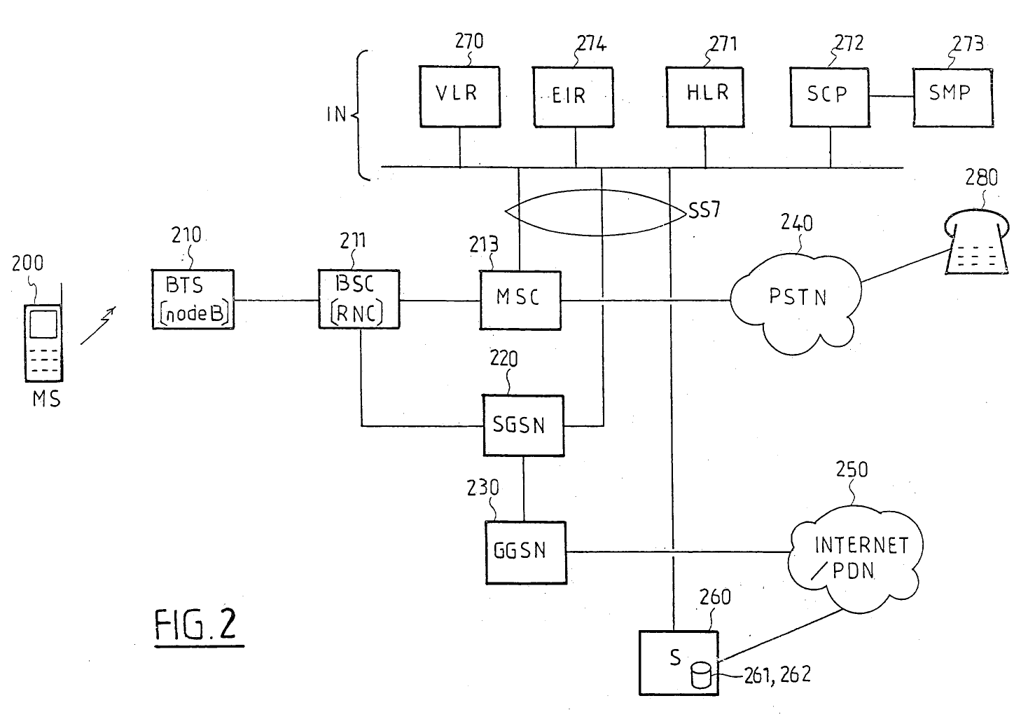

FIG. 2 is a schematic representation of the architecture of a GPRS/GSM system or of a UMTS system in which a mode of embodiment of the invention is used.

The invention is generally applicable to a network that can offer a user terminal, particularly a mobile terminal, both access in circuit mode and access in packet mode. We will recall that for a circuit type connection, a portion of the transmission resource is reserved for the duration of a communication: this may be a frequency, a line, a segment of a physical frame, etc., for example. Conversely, in a packet mode connection, the user accesses the resource only when he has data to be transmitted, and therefore only a virtual circuit is established between the entities in communication. Traditionally, the connection in circuit mode is suited to voice communications while the connection in packet mode is preferred for burst data traffic such as IP (Internet Protocol) datagrams or X25 packets.

The GSM system, which only offers access in circuit mode, was adapted in the GPRS (General Packet Radio Service) standard to also support access in packet mode. Additionally, the third generation mobile telephone system (UMTS) will also offer both types of connection. Users of the GPRS system (if they have a class A mobile terminal) or of the UMTS system will be able to establish a connection in packet mode for a telephone conversation, for example, and a connection in packet mode, for example to search for information at an Internet site, simultaneously. Likewise, the ISDN network allows the establishment of a connection in circuit mode on channel B at the same time as a connection in packet mode on channel D.

According to the method of this invention, when a user sends a call to establish a connection in circuit mode or in packet mode, the network verifies whether the user making the call or the user called is a subscriber to the advertising messaging service. If this is the case, the network sends a call indicator to the advertising server with the references for the user concerned, namely his caller or callee number, his type of terminal, his rate identification, his access characteristics, etc.

After verifying the user's access rights to the messaging service and searching its database for his advertising preferences, the server establishes a virtual circuit with the subscriber's user terminal and transmits to him the advertising information corresponding to his preferences and/or to his location. To do this, the server will advantageously use the push mode transmission of the TCP protocol, which will make it possible to send its data immediately to the user's application layer. The advertising information is transmitted from the server's advertising database and is presented in a format that depends on the terminal used by the user, for example, in the form of advertising banners if the size of the screen allows this.

The resources used for the virtual circuit are taken from the available bandwidth subscribed to by the user or fixed by the network operator in order to guarantee a minimum quality of service (Best Effort). In both cases, the advertising information is transmitted over a virtual circuit independent of and simultaneous with the first connection, so that the communication on this first connection is not disturbed at all.

The advertising information displayed may contain references to Internet sites or to other advertising information. The subscriber user will browse, for example, among the advertising banners. If applicable, the server will reroute the call to the URL address attached to the advertising banner. The number of advertisements thus consulted, their total display time and, in general, the consultation statistics will be obtained by the server from the number of times the subscriber user has clicked on these banners and the length of the connection. The network operator collecting advertising receipts thanks to this service may offer a favorable communication rate to its subscribers.

FIG. 1 illustrates the general principle of the invention. When a user asks via his terminal (100) to establish a first communication by means of a circuit mode connection (1) with another user (180) or a packet mode connection (1′) with, for example, for the Internet, a URL address (190), the service management system (170) is alerted of this request. The management system (170) then verifies in the database (171) containing the user-related information whether the caller (100) or the person called (180, 190) subscribes to the information dissemination service. If the answer is yes, the service management system activates the server (160) and supplies it with the data useful for establishing a connection (2) in packet mode with the subscriber (assumed here to be the caller). The server then transmits to the subscriber, over a second connection, the pertinent information stored in the database (161) based on the subscriber's characteristics, for example, his preferences, stored in the database (162), as well as his location. The information may in particular be transmitted in the form of IP packets in PUSH mode. Advantageously, the server will indicate to the subscriber, for example by means of a specific message, the position of the window for viewing the information on the user terminal. The second connection (2) is established at the same time as the first connection ((1), (1′)) as soon as the establishment of the first connection is confirmed (call confirmation). The user has the option of establishing other connections from his terminal (100). When the first connection or, in general, when all the connections except for the connection with the server (160) is/are freed up, the management system (170) is alerted of this. It then informs the server (160), which frees up the second connection (2).

FIG. 2 shows the implementation of a mode of embodiment of the invention in connection with a GSM/GPRS network or a UMTS network. The acronyms in brackets refer to the UMTS system when it differs from the GSM/GPRS system. As the operation of the invention is analogous for the two networks, the description will be given for the GSM/GPRS network and only the difference will be indicated if necessary.

We assume that the user has a terminal (200), for example a mobile station (MS) connected or not to a personal computer (not shown). The mobile station is served by a base station comprising a BTS or Base Transceiver Station sender/receiver (210) (B node in the UMTS system) controlled by the BSC or Base Station Controller (211) (RNC or Radio Network Controller in the UMTS system) receiving control information from node (220) in packet mode and from node (213) in circuit mode. The controller (211) in particular manages the radio interface channels and the handovers of the mobile stations entering and leaving the cell. The channels may either be reserved for connections in circuit mode or shared for connections in packet mode. The unit consisting of the BTS (B node) and the BSC (RNC) forms a Base Station Subsystem also called BSS. (RNS stands for Radio Network System). The controller (211) is connected to an MSC (213) or Mobile Switch Center of the traditional GSM network via which the communications transit in circuit mode to the Public Switched Telephone Network (PSTN) (240).

The controller (211) is also connected to an SGSN node of GPRS Service (Serving GPRS Support Node) through which the communications in packet mode transit. The connection to a packet mode transport network (PDN) or to the Internet is handled by a GGSN (230) or Gateway Support Node. An advertising information server (260) with a database (261) is connected to this network. The MSC switch, the SGSN service node and the advertising information server are connected via the signaling network (SS7) in accordance with CCITT Recommendation No. 7 to the VLR (Visitor Location Register) database (270), to the HRL (Home Location Register) database (271), to the EIR (Equipment Interface Register) database (274) and to a service control point (SCP) (272) intended for a specialized SMP (Service Management Point) (273) responsible for administering the service. The VLR database contains information related to all the mobile stations passing through its service area, and the HLR database contains the user's permanent information, for example his International Mobile Subscriber Identity (IMSI). The EIR database contains the

information pertaining to the user's equipment like, for example, the IMEI (International Mobile Equipment Identity).

When a user asks to establish a communication (or when a new application is launched on the terminal), the connection mode required is determined by the BSC based on the type of communication (or application) requested. The MSC switch or the SGSN node, depending on the case, signals the call request and the customary checks are performed in the HLR database. The Service Control Point (SCP) then verifies whether the user subscribes to the advertising messaging service and, if the answer is yes, the service management point (SMP) sends information to the advertising messaging server (260) via the SS7 semaphore network to establish a connection in packet mode with the subscriber. The server has a database (261) of subscriber users containing, for each subscriber, the user's references, his access rights, his advertising preferences, his connection time to the URLs associated with the advertising banners and, in general, all pertinent information concerning his subscriber profile or concerning his use of the service. This database may be set up using information supplied by the user customer when he subscribes to the service, rounded out by information already present in the HLR database. The server can also obtain from the VLR file the user's current location if the user has also subscribed to the localization service. After having verified his access rights, the server then selects, based on the subscriber's advertising preferences and/or the subscriber's location, information from the advertising database (262), in a format suited to display on the terminal. The type of terminal is indicated to the server by an IMEI number available in the EIR database, and any update information. The frequency of transmission of the advertising information is selected by the subscriber user or is determined by the network operator. It is sent immediately to the application level and is displayed directly on the screen in a reserved area. The advertising information can offer menus or hypertext links that refer either to other advertising information in the database or to advertisers' sites. All the selection and browsing information is used by the server to update its databases and provide the network operator with the necessary elements to calculate the reduction ratio applicable to the communication.

Of course, the advertising messaging service is not limited to the caller subscriber user. If the user called is also a subscriber or if he is the only subscriber, the server will be able to transmit advertising information to him according to the procedure indicated above. Even though he is not a priori charged for the communication, the person called will capitalize on the use time of the advertising service, which will allow him to benefit from a favorable rate for a subsequent communication.

The subscriber will have the option, by sending a particular code, of not or no longer receiving advertising information during a communication. In this case, the server takes the event into account for billing purposes and sends an acknowledgment of the end of the connection. Likewise, when the first communication ends, the server is so alerted by the SMP service manager and immediately ends the connection with the subscriber. If the subscriber has established several communications, it is the end of the last active communication that triggers the end of the communication with the server.

Although the invention has been illustrated in is application to GSM/GPRS and UMTS networks, it is applicable, as we have seen, to any telecommunication network capable of offering a connection in circuit mode and a connection in packet mode at the same time. For example, the invention will be applicable to an ISDN network offering a connection in circuit mode on channel B and a connection in packet mode on channel D.

Likewise, although the description essentially presented an advertising information server, the invention is not limited to this type of information. It can allow the dissemination more particularly of network information, information about traffic, funny stories, videogags, etc. The user subscriber is thus freed from the connection phase for this or these types of information. The presentation on the user's screen is not limited to banners; it may in general take the form of texts, images or multimedia data.

1) Method for transmitting information, particularly advertising information, to a user terminal (100, 200) that can access a telecommunication network in packet mode and in circuit mode, wherein when a first connection ((1), (1′)) via the network is requested by said terminal according to either mode, a second connection in packet mode (2) is established at the same time as the first connection between said terminal and an information server (160, 260), and the server then transmits said information to the user terminal by means of the second connection.

2) Method for transmitting information as claimed in claim 1, wherein the server establishes a second connection upon confirmation of the establishment of the first connection.

3) Method for transmitting information as claimed in claim 1 or 2, wherein as the user terminal accesses the network by means of a multiplicity of connections including the first and second connections, the server frees up the second connection when the end of the other connections is detected by the network.

4) Method for transmitting information as claimed in claims 1 through 3, wherein a first database (171, 270, 271) is consulted at the time the first connection is established and a second connection is established only if said database indicates that the user subscribes to the information service.

5) Method for transmitting information as claimed in claim 4, wherein the server selects from a second database (162, 262) information to be transmitted to the subscriber based on the subscriber's characteristics appearing in a third database (161, 261).

6) Method for transmitting information as claimed in claim 5, wherein said characteristics include the subscriber's preferences.

7) Method for transmitting information as claimed in claims 5 or 6, wherein the server selects information from the second database to be transmitted to the subscriber based on the subscriber's location.

8) Method for transmitting information as claimed in one of the preceding claims, wherein the server selects a presentation format for the information based on the type of user terminal.

9) Method for transmitting information as claimed in claim 8, wherein the server indicates to the user terminal a display position for said information on its screen.

10) Method for transmitting information as claimed in one of the preceding claims, wherein as the information is advertising in nature and represented on the terminal in the form of banners, the number of clicks on these banners and/or the display time of said banners is taken into account to calculate the billing for the communication over the connection or connections other than the second connection.

11) Method for transmitting information as claimed in one of the preceding claims, wherein said information is transported to the user terminal in the form of TCP segments in which the PSH push flag is raised.

12) Method for transmitting information as claimed in one of the preceding claims, wherein the telecommunication network is a UMTS network.

13) Method for transmitting information as claimed in one of claims 1 through 12, wherein the telecommunication network is a GSM/GPRS network.

14) Method for transmitting information as claimed in one of claims 1 through 11, wherein the telecommunication network is an ISDN network.

15) System for transmitting information, particularly advertising information, to a user terminal (100, 200) by means of a telecommunication network offering access in packet mode and access in circuit mode, the system comprising service management means (170, 272, 273) and an information server (160), the system being characterized by the fact that the service management means are suited to receiving a connection request from the user terminal according to either mode and by the fact that said server is suited to establishing a second connection in packet mode at the same time as the first connection with said terminal, said server being suited to then transmitting said information to said terminal by means of a second connection.

16) System for transmitting information as claimed in claim 15, wherein the service management means (170, 272, 273) are suited to supplying the server (160) with the information elements allowing it to establish the second connection upon confirmation of the establishment of the first connection.

17) System for transmitting information as claimed in claim 15 or 16, wherein as the user terminal accesses said network by means of a multiplicity of connections including the first and the second connections, the service management means are suited to supplying the server with the information elements allowing it to free up the second connection when the end of the other connections is signaled to them.

18) System for transmitting information as claimed one of claims 16 or 17, wherein it also includes a first database (171, 270, 271), the service management means being capable of consulting the first database and of supplying said information elements to the server only if the first database indicates that the user subscribes to the information service.

19) System for transmitting information as claimed in one of claims 15 through 18, wherein the server (160, 260) includes a second database (162, 262) containing information to be transmitted to the subscribers and a third database (161, 261) containing the subscriber's characteristics.

20) System for transmitting information as claimed in claim 19, wherein said characteristics include subscribers' preferences.

21) System for transmitting information as claimed in one of claims 19 or 20, wherein the service management means are capable of supplying the server with information pertaining to the user's location and wherein the server is capable of selecting from a second database information to be transmitted to the subscriber based on said location information.

22) System for transmitting information as claimed in one of claims 15 through 21, wherein the server is capable of selecting a presentation format for the information based on the type of user terminal.

23) System for transmitting information as claimed in claim 22, wherein the server indicates to the user terminal a display position for said information on its screen.

24) Smart network service management software characterized in that it is executed by a processor and is able to operate the service management means of the transmission system as claimed in one of claims 15 through 18 or 21.

25) Information server control software, characterized in that it is executed by a processor and is capable of operating the server of the transmission system as claimed in claims 15 through 17.

26) Information server database management software, characterized in that when it is executed by a processor, it is capable of executing the steps of the method as claimed in one of claims 5 through 10.
